(19) United States
(12) Patent Application Publication
(10) Pub. No.: US 2003/0214690 A1
(43) Pub. Date: Nov. 20, 2003

(54) Holographic polymer photonic crystal

(76) Inventors: Michael J. Escuti, Best (NL); Gregory P. Crawford, Providence, RI (US)

Correspondence Address: HALE AND DORR, LLP, 60 STATE STREET, BOSTON, MA, 02109

(21) Appl. No.: 10/304,578

(22) Filed: Nov. 26, 2002

Related U.S. Application Data
(60) Provisional application No. 60/333,327, filed on Nov. 26, 2001.

(51) Int. Cl. G02B 5/32

(52) U.S. Cl. 359/15

(57) ABSTRACT

A photonic crystal having a polymer matrix of a first index of refraction and a second material arranged in a crystal lattice and having a second index of refraction is presented. The second material may be an active material such as a liquid crystal and the active material may have an optical property that can be modulated by an external field. Methods for making such crystals using holographic polymerization of a photosensitive monomer in a composition including the monomer and a non-photosensitive material are described. In some aspects, the photosensitive monomer and the non-photosensitive material, e.g., a liquid crystal, may be phase-separated upon exposure to a pre-calculated interference pattern of light such as is obtained by the superposition of a number of coherent light beams. Various applications are described, such as in optical communication switching, filtering, display devices and other commercial and scientific applications.

### RELATED APPLICATIONS

This application claims priority under 35 U.S.C. §19(e) to U.S. Provisional Patent Application Serial No. 60/333,327, entitled “Switchable Photonic Crystal Formed With Holographic Polymer Dispersed Liquid Crystals,” filed on Nov. 26, 2001, which is hereby incorporated by reference in its entirety.

### TECHNICAL FIELD

The present invention generally relates to photonic devices and methods for manufacturing such devices. More particularly, aspects of the present invention are directed to photonic crystals comprising a polymer matrix and a lattice of active material domains. The active material may comprise a liquid crystal. Other aspects of the invention are directed to methods for providing a polymer matrix and a second material in a lattice by phase separation of a photosensitive composition containing at least a photosensitive monomer and the second material. Yet other aspects of the invention are directed to modulating an optical characteristic of an active photonic crystal using an external field.

### BACKGROUND

Photonic crystals have spatially-periodic dielectric functions, and are so named in an analogy to solid state physics. In photonic crystals, photons of frequencies within a forbidden band are not allowed to propagate through the material, similar to the way that the propagation of electrons with particular energies is forbidden in semiconductor crystals if they reside in a particular energy band gap.

Generally, “photonic crystals” (PhCs) are materials having a periodic dielectric profile that can lead to a range of “forbidden” frequencies that (in some cases) will be unable to propagate in any direction for any polarization within the material. Called a “photonic band gap” (PBG), this range of frequencies is analogous to an electronic band gap, and also arises from the presence of a lattice or crystal. However, in this case the lattice scale is on the order of the wavelength of light (0.1 mm to 2 mm) rather than on the order of atoms as in the solid-state physics case. The geometry of the pattern as well as the material properties of the substrate control the photonic band structure (the dispersion). Generally, a high refractive index contrast is required for a full band gap (where any polarization in any direction of a particular frequency is prohibited); however, materials with lower contrasts can find utility in applications where the polarization or direction of incident light is limited in some way. Photonic crystals are described further in (J. D. Joannopoulos et al., Photonic Crystals-Molding the Flow of Light, Princeton University Press, Princeton, N.J. (1995); V. Mizeikis et al., J. Photochem. and Photobio. C: Photochemistry Reviews 2, 35 (2001)).

Photonic band gap materials find applications in the miniaturization, integration, and simplification of many active and passive optical circuits that commonly require complex combinations of electronics and photonics (J. D. Joannopoulos et al., Nature 386, 143 (1997)). Some benefits of this technology include reduced power dissipation and higher bandwidths for communication links and optical computing.

One way to describe the interaction of light with and within a PhC is in the context of multiple scattering and diffraction (V. Mizeikis et al., Id). Defects, such as those resulting from a local change in the dielectric periodicity, modify the lattice and affect the local photonic band structure. This localization property enables PhCs to manifest unique optical resonances.

The first experimental photonic band gap (E. Yablonovitch and T. J. Gmitter, Phys. Rev. Lett. 63, 1950 (1989)) in a face-centered-cubic (fcc) lattice operated at microwave frequencies and was eventually recognized as only a pseudo band gap. The first full PBG was seen shortly thereafter (E. Yablonovitch et al., Phys. Rev. Lett. 67, 2295 (1991)) using a diamond-like structure.

Literature in this field includes a paper by Yablonovitch (Phys. Rev. Lett., 58, 2059-, (1987)), and has been developed in theory (J. D. Joannopoulos, et al. (1995)); numerical modeling methods (K. Ho, et al., Phys. Rev. Lett., 65, 3152 (1990); R. Meade, et al., Phys. Rev. B, 48, 8434 (1993); and J. Pendry and P. Bell, in Photonic Bandgap Materials, NATA ASI Series E, C. M. Soukoulis, Ed. Dordrecht: Kluwer Academic Publishers (1996)), and devices (T. F. Krauss and R. M. deLaRue, “Photonic crystals in the optical regime—past, present and future,” Quantum Electron., 23, 51 (1999); S. Noda, et al., Nature, 407, 608 (2000)).

The periodicity of photonic crystals may be in one, two, or three dimensions and they can be fabricated in several ways. Reactive ion etching (J. Obrien, et al., Electron. Letter, 32, 2243 (1996)), two-photon polymerization (H. Sun, et al., Appl. Phys. Lett., 74, 786 (1998)), and aluminum oxide films (H. Masuda, et al., J. Appl. Phys., 39, L1039 (2000)) are common approaches. Colloidal suspensions of opal spheres (S. John, in Photonic Bandgap Materials, C. Sokoulis, Ed. Dordrecht: Kulwer Academic Publishers (1996)) and polystyrene spheres (J. J. Wijnhoven and W. Vos, Science, 281, 802 (1998)) have been used to produce self-assembled arrays that can be used as templates for a higher contrast material.

All of these approaches result in “passive” devices, where the dielectric function is fixed. However, the photon localization in these materials has led to demonstrations of spontaneous emission, wavelength-dependent leakage from planar waveguides, and beamsplitters. So-called “holey fibers” have been shown to guide light in air-core (R. F. Cregan, et al., Science, 285, 1537 (1999)) as well as photonic fibers in the form of microporous silica (A. Ortigosa-Blanch, J. C., et al., Opt. Lett., 25, 484 (2000)).

These approaches also present processing challenges because these methods construct the photonic crystals incrementally, or one layer at a time. For example, lithographic or etching methods form one two-dimensional plane of material at a time and sequentially stack a plurality of layers on top of one another to obtain a three-dimensional crystal. Also, the colloidal self-assembly method relies on particles within a colloidal suspension to settle on top of one another sequentially to build up a three-dimensional crystal.

Another approach to producing photonic crystals uses holography to form two- and three-dimensional periodic structures. These structures are sometimes referred to as holographic polymer dispersed liquid crystals (H-PDLCs). In most cases, a photosensitive resin is exposed and processed as a holographic emulsion. Unreacted monomer is removed by solvent extraction to form voids (non-polymer regions) filled with air, resulting in a high-index difference photonic crystal. The voids can be backfilled with polycrystalline titanium dioxides having an index of refraction higher than that of the polymer to provide yet another approach to a high index difference crystal (S. Shoji and S. Kawata, Appl. Phys. Lett., 76, 2668 (2000); M. Campbell, et al., Nature, 404, 53 (2000)). In one case, the resin is used as a template for a subsequent ion-etch of a silicon substrate (V. Berger, et al., J. Appl. Phys., 82, 60 (1997)). In all of these cases, passive non-switchable photonic crystals result.

Tunable photonic crystals whose index profile can be modified by temperature have been demonstrated (K. Yoshino, et al., Appl. Phys. Lett., 75, 932-934 (1999)). In this case, the colloidal suspension of synthetic opal spheres is backfilled with a liquid crystal, whose average index of refraction changes with temperature. This index change leads to a wavelength shift in the stop band boundaries and a change in the bandgap width.

These methods create a polymer matrix that then requires flushing and/or backfilling with a second material if a two-material lattice is to be obtained. Thus, it is necessary in prior art methods to leave an open or self-connected network of channels which can be flushed and/or backfilled with a second optical material. Not only is this method cumbersome, but it represents a limitation on the geometry of the photonic crystals of the prior art which in turn limits the optical and photonic utility of the crystals.

While passive photonic devices have been manufactured in one of several ways, as described above, it is desired to provide photonic crystals of an unlimited geometrical variety. It is further desired to provide simple and effective methods for producing active photonic crystals.

### SUMMARY

The present invention overcomes at least some of the limitations described above, and in some aspects provides a photonic device having a two- or three-dimensional crystal lattice, which may include a polymer matrix and a second material, such as an active material. The matrix and the second material may have different indices of refraction, providing useful optical properties, and the crystal may be employed as a photonic device. If an external field, such as an electromagnetic field, is applied to the active material susceptible to the external field, useful manipulation or modulation of a characteristic, such as the index of refraction of the active material, can be achieved.

Photonic crystal structures may be generally constructed in one, two or three dimensions as called for by the application at hand. By one-dimensional it is meant a structure that substantially only has symmetry variations in one dimension. For example, a structure comprising a plurality of parallel uniform planes is referred to as one-dimensional since variation only occurs along an axis normal to the planes and not in the other two dimensions lying in the face of the planes. A two-dimensional structure is one in which symmetry variations occur only in two dimensions. For example, a structure comprising a plurality of parallel rods or tubes or fibers is considered two-dimensional because variations only occur in the two dimensions normal to the (parallel) axes of the rods, tubes, or fibers. Of course, a strictly two-dimensional structure having only two dimensions as in a flat thin sheet is also two-dimensional and may have variations in the two dimensions comprising the face of the sheet. Finally, a three-dimensional structure is one in which symmetry variations occur in all three dimensions of the structure. Most lattices found in nature are three-dimensional and include several well-known lattice structures such as face-centered cubic (fcc), body-centered cubic (bcc), hexagonal close-packed (hcp) and other lattice structures.

In one or more embodiments of the present invention, a photonic crystal includes a polymer matrix containing a plurality of regions, each region substantially occupied by one or more materials. In one or more embodiments, the regions are topologically-unconnected and/or closed. By “topologically-unconnected” regions it is generally meant regions having distinct defining non-intersecting surfaces, between which some other intervening regions may be disposed. By “closed” regions it is meant that the regions are self-contained within a continuous surface, such as a droplet or a cube or any other surface that could be envisioned to be completely confining, delineating a space interior to the closed region and a space exterior to the closed region. A closed region is not susceptible to backfilling. Backfilling, as it is used in the prior art, involves filling open or topologically-connected voids with a liquid that is pushed into the voids from an external source.

Some embodiments of the present invention provide a photonic crystal that includes a polymer matrix and a plurality of domains within the matrix filled with an active material such as a liquid crystal. The active material and/or the matrix may influence a propagating light beam in a desired manner. The precise operation of the photonic crystal will be influenced by numerous factors, including the respective indices of refraction of the lattice domains, the size and geometry of the lattice domains, the wavelength or spectrum of light or radiation incident onto the crystal and other parameters and properties of the crystal and the radiation incident thereon.

The present invention includes both photonic devices and methods for making and using such devices. The photonic devices may also be part of a system employing the devices, said system optionally comprising, without limitation, hardware and/or software or other auxiliary components.

Accordingly, one embodiment of the present invention is directed to a method for modulating a light source, comprising providing a composition including a photosensitive monomer and an active material; forming an interference pattern of light from at least three substantially-additive coherent light beams; applying the interference pattern of light to the composition; polymerizing the photosensitive monomer, thereby phase-separating the composition into a polymer matrix and a plurality of active material domains, said active material domains arranged in a two- or three-dimensional lattice; and applying an external field to the active material to modify an optical characteristic of the active material and modulate the light source.

Another embodiment is directed to an optical device, comprising a three-dimensional polymer matrix; and an active material disposed in and substantially filling a plurality of topologically-unconnected, closed domains within the polymer matrix. The domains define locations of a three-dimensional lattice, and the active material has an optical characteristic that may be actively controlled using an externally-applied field.

Yet another embodiment is directed to a computer system for calculating an interference pattern of light for application to a photosensitive material. The computer system includes a storage device that stores instructions corresponding to a governing set of equations; an input interface that receives input data corresponding to a desired optical characteristic of the photosensitive material; a processor operative to receive the input data, execute the stored instructions on the input data to calculate an intensity field for each of a plurality of simulated coherent light beams and sum the calculated intensity fields to yield a simulated two- or three-dimensional interference pattern of light having a plurality of bright or dark regions; and an output interface that provides an output representative of the simulated two- or three-dimensional interference pattern of light, the output adapted for generation of an actual two- or three-dimensional interference pattern of light that locally modifies an optical characteristic of the photosensitive material corresponding to the bright or dark regions.

Still another embodiment is directed to a method for making an active optical component, including providing a composition including a photosensitive monomer and an active material; forming an interference pattern of light from at least three substantially-additive coherent light beams; applying the interference pattern of light to the composition; and polymerizing the photosensitive monomer using the interference pattern of light, thereby phase-separating the composition to yield a polymer matrix and a two- or three-dimensional lattice of the active material within the polymer matrix.

In another embodiment a photonic device fabrication method is provided. The method includes applying light in a selected light intensity pattern to a composition including a photosensitive monomer and an active material; phase-separating the composition into a polymer matrix having a three-dimensional morphology corresponding to the light intensity pattern and a plurality of active material-filled topologically-unconnected, closed regions contained within the polymer matrix; wherein said regions define locations of a three-dimensional lattice; and wherein all regions of the polymer matrix are formed substantially at the same time and globally over the device in its entirety by exposing the device as a whole to the light intensity pattern.

Another embodiment of the present invention is directed to a method for making a photonic device includes applying light in a light intensity pattern to a composition including at least a first material and a second material, the first material having a first index of refraction and the second material having a second index of refraction, wherein the first and second indices of refraction are different and wherein at least the first material is a photosensitive monomer; phase-separating the composition into a plurality of regions by polymerizing at least the first materials to yield a polymer matrix and a plurality of topologically-unconnected regions disposed within the polymer matrix; wherein the topologically-unconnected regions comprise a lattice having domains substantially occupied by second material. In one or more embodiments, the topologically-unconnected regions form a two- or three-dimensional lattice.

A further embodiment is directed to an optical device, comprising a composition that is phase-separated by application of a light pattern into a first region comprising a three-dimensional polymer matrix comprising a first polymer having a first index of refraction; and a second region comprising a second polymer, having a second index of refraction, disposed in and substantially filling a plurality topologically-unconnected, closed domains within the polymer matrix, said domains defining locations of a three-dimensional photonic lattice.

Some applications for such photonic devices, systems and methods include optical filters, switches, gratings, display devices, tunable bandgaps, optical communication systems and digital networks.

### BRIEF DESCRIPTION OF THE DRAWINGS

FIG. 1 illustrates phase separation of a photosensitive monomer and a liquid crystal to form different regions of a lattice due to a light-intensity pattern.

FIG. 2 illustrates exemplary simulation outputs showing a variety of holographic beam patterns.

FIG. 3 illustrates a variety of exemplary holographic light intensity patterns and the corresponding number of coherent beams used to generate the light intensity patterns.

FIG. 4 illustrates exemplary two- and three-dimensional patterns generated by application of three or four individual light beams to a sample.

FIG. 5 illustrates exemplary light-intensity patterns generated by a plurality of coherent beams which are superposed to arrive at a structure having a matrix and closed regions lying within the matrix.

FIG. 6 illustrates the use of six individual beams to generate an exemplary hexagonal close-packed lattice.

FIG. 7 illustrates an exemplary face-centered cubic lattice.

FIG. 8 illustrates an exemplary transverse two-dimensional lattice embodiment.

FIG. 9 illustrates exemplary propagation and normalized polarization vectors used to generate the lattice of FIG. 8.

FIG. 10(a) illustrates a convenient coordinate system for use in the present analysis.

FIG. 10(b) illustrates a tabular conversion between spherical/natural coordinates and Cartesian coordinates for the coordinate system of FIG. 10(a).

FIG. 11 illustrates an exemplary system layout and geometry for irradiating a sample using a laser.

FIG. 12 illustrates an exemplary plot of transmittance versus wavelength at two different thicknesses of a fcc photonic crystal.

FIG. 13 illustrates the specular reflectance as a function of the applied electric field according to one embodiment of the invention

FIG. 14 illustrates an exemplary schematic diagram of a circuit for applying an external field to an active sample.

FIG. 15 illustrates an exemplary schematic diagram of a computer system used to generate a plurality of beam control signals.

FIG. 16 illustrates exemplary waveforms for modulating an AC signal to obtain a signal usable for modulating an external field.

FIG. 17 illustrates an exemplary diagram showing steps of generating a photonic lattice and modulating its active material.

### DETAILED DESCRIPTION AND PREFERRED EMBODIMENTS

The following description describes various aspects of some embodiments of the present invention, including the preferred embodiments thereof. The description is best understood when read in conjunction with the accompanying figures, which illustrate various aspects of the embodiments described herein. Various embodiments of the present invention have been described in U.S. Provisional Patent Application Serial No. 60/333,327 incorporated by reference in its entirety.

Holography can be defined as a process for capturing an interference pattern between two mutually-coherent fields of radiation within a two- or three-dimensional medium. The captured interference pattern is then typically combined with an appropriate light source to fully or partially reconstruct the original field of radiation. The resulting “hologram” is essentially a complex diffraction grating in two- or three-dimensions. A three-dimensional appearance is possible in holograms because the coherent recording process allows phase information to be retained and reproduced along with amplitude information when illuminated with appropriate lighting. This is in contrast to ordinary photography, which lacks phase information and only delivers amplitude information at each point on the surface of a photograph.

Variations of the holographic process may be used to form patterns and images in two or three dimensions. Some embodiments of the present invention use holographic techniques to generate interference patterns of light that are then used to form a two- or three-dimensional lattice by polymerizing a photosensitive monomer.

One aspect of the present invention provides for exposing a composition of a photosensitive monomer and a second material, which may be a non-photosensitive material, to an appropriate type and intensity of light such that the monomer within the composition polymerizes and the second material in the composition does not polymerize. A photosensitive monomer exposed to a light of a certain intensity or frequency, including light in a visible or non-visible band, such as the infrared (IR) or ultraviolet (UV) bands may react or become cross-linked to form a polymer. As a result, a monomer may be polymerized according to a pattern of light that is incident thereon. In such a composition, the second material phase separates from polymerized material.

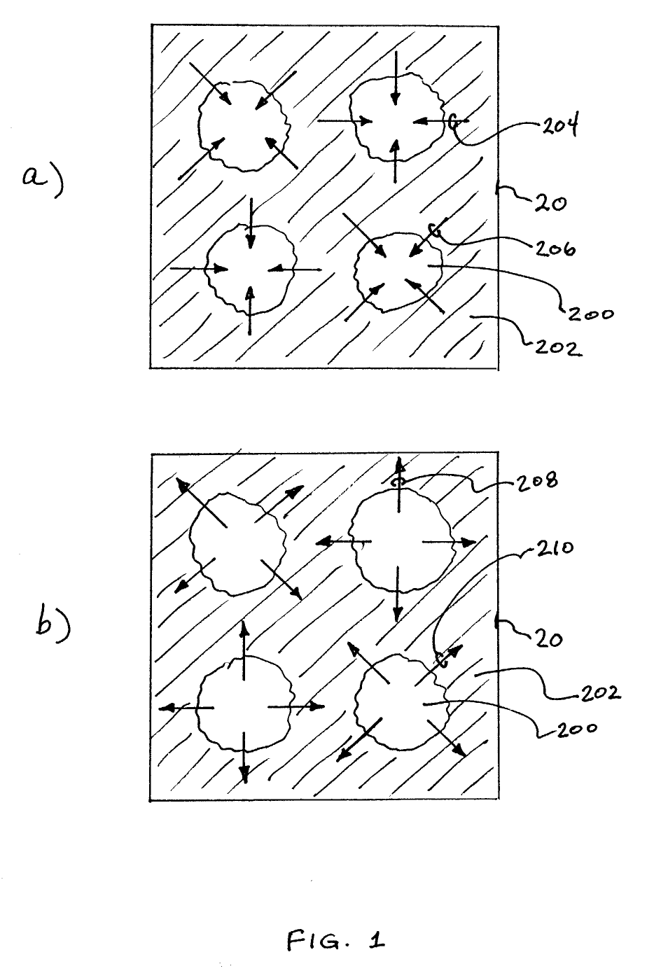

Phase separation of a photosensitive composition is illustrated in FIG. 1. The figure shows a pattern 20 having bright 200 and dark 202 regions created by an interference pattern of light. In this example, FIG. 1(a) is illustrated showing the photosensitive monomer being drawn into bright regions 200, as indicated by arrows 204 and 206. Conversely, in FIG. 1(b), the non-photosensitive material is shown to exit the bright regions 200 and enter the dark regions 202. This migration is illustrated by arrows 208 and 210. The process illustrated in FIG. 1 may be carried out relatively quickly, on the order of one second or less, which is much quicker than some prior art methods that require days to form a photonic crystal. Also, the rate of phase separation may depend on the intensity or an intensity difference between bright regions 200 and dark regions 202. The example given above, in which the polymerizing monomer migrates into the bright regions 200 and the non-photosensitive material migrates into the dark regions 202 is not meant to be limiting, and it should be understood that the converse might also be true for some materials.

The phase separation will follow or correspond to the incident pattern of light. Such phase separation may be carried out in one, two, or three dimensions. It is then understood that in order to obtain a two- or three-dimensional polymer matrix as described above, a two- or three-dimensional intensity pattern of light is used to form the polymer matrix.

It should be appreciated that the process for forming the two- or three-dimensional photonic crystal may be carried out as a single step or as a plurality of steps over time. That is, the photosensitive monomer may be exposed in bulk and as a whole to an interference pattern of light for a sufficient time duration and at a sufficient power and/or intensity level to fully form the polymer matrix, or the monomer may be exposed to shorter or weaker doses of light so as to form the polymer matrix at a slower rate or even at incremental rates. The shorter doses of light may comprise a pulse of a certain duty cycle or a pulse program having some pre-determined sequence. Furthermore, the pulse sequence may be determined in real time or as part of a feedback process. So, for example, a first polymerization step might polymerize a first fraction of the monomer, and a second polymerization step might polymerize a second (or the remaining) fraction of the monomer. When exposing the composition to a plurality of light beams, the light patterns may be the same or different. In one or more embodiments, different light patterns are used to superpose two or more patterns on the monomer composition, thereby providing more complex lattice structures.

Furthermore, the process of polymerization may be carried out in distinct spatial steps, polymerizing a first region or set of regions of the monomer upon exposure to a first intensity pattern of light, then polymerizing a second region or set of regions of the monomer upon exposure to a second intensity pattern of light. The first and second regions or sets of regions may be overlapping in space or may be spatially discrete and non-overlapping.

Various embodiments of the present invention may utilize two lasers to form respective two sets of 3 or more coherent beams, wherein the sets of beams from each of the two lasers are self-coherent, but beams from different lasers are incoherent with one another. As an example, an Argon ion (Ar+) laser may be used to generate a first set of three coherent beams incident on a sample at a wavelength of 488 nm. A second laser, such as a NdYag laser, operating at 532 nm generates a second set of three beams. The respective sets of beams from each of the lasers will be coherent with one another, however, as described previously, beams from one laser will be incoherent with beams of the other laser. Nonetheless, it is possible to form lattices by superposing interference patterns of light generated by one or more laser beams, which may be coherent or incoherent with respect to one another. It should be pointed out that the resulting lattice structures may contain defects as a result of said superposition, and that such defects may be intentionally designed or engineered into the resulting crystal lattice.

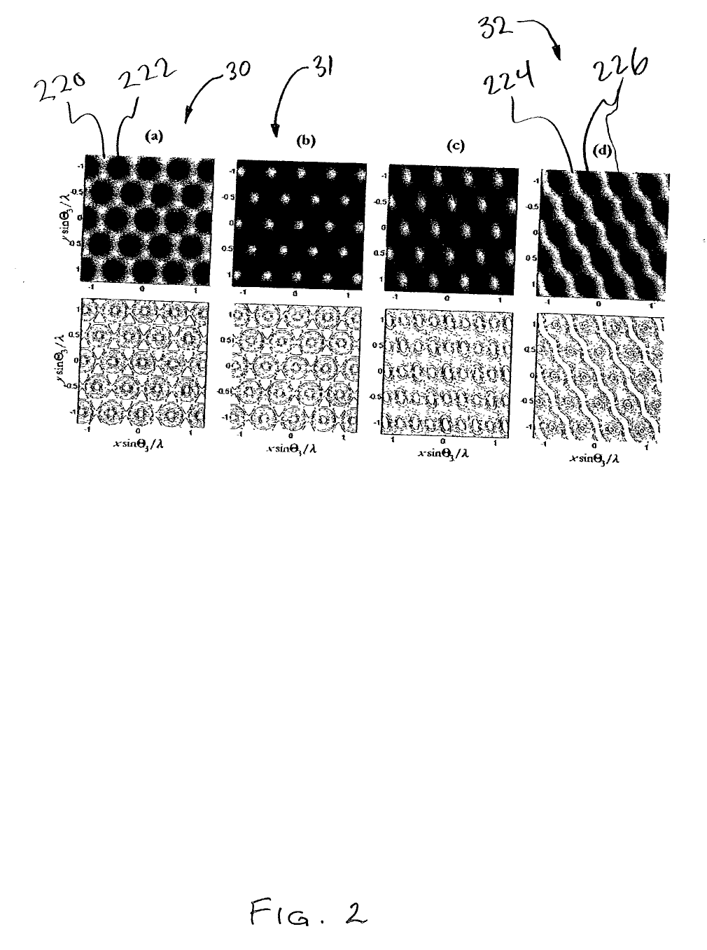

FIG. 2 illustrates several light patterns which may be obtained using the process described with respect to FIG. 1 above. FIGS. 2(a)-(d) illustrate patterns resulting from superposition of several beams of coherent light to obtain alternating light and dark regions. For example, in FIG. 2(a), a hexagonal arrangement is shown in panel 30 having bright regions 220 which may form a polymer matrix if exposed onto a photosensitive composition, and dark regions 222 which may become filled with the non-photosensitive material in the composition. It is known to those skilled in the art that a photoinitiator material may be included in such photosensitive compositions to trigger or accelerate or otherwise change a threshold for activation of the polymerization process. An example of a photosensitive composition usable in some or all embodiments of the present invention is presented later in this discussion.

Note that the dark regions 222 illustrated in FIG. 2(a) are substantially disconnected or have an unconnected topology, whereas the bright regions illustrated in FIG. 2(a) are topologically-connected according to the definitions given previously. To further illustrate this concept, the dark areas in FIG. 2(b), shown at panel 31, are connected and can be imagined to form a matrix defining a crystal containing the bright regions of FIG. 2(b), which are not connected and form closed regions. Some cases arise, such as shown in FIG. 2(d), in which dark regions 226 and bright regions 224 form extended striped or sheet-like structures.

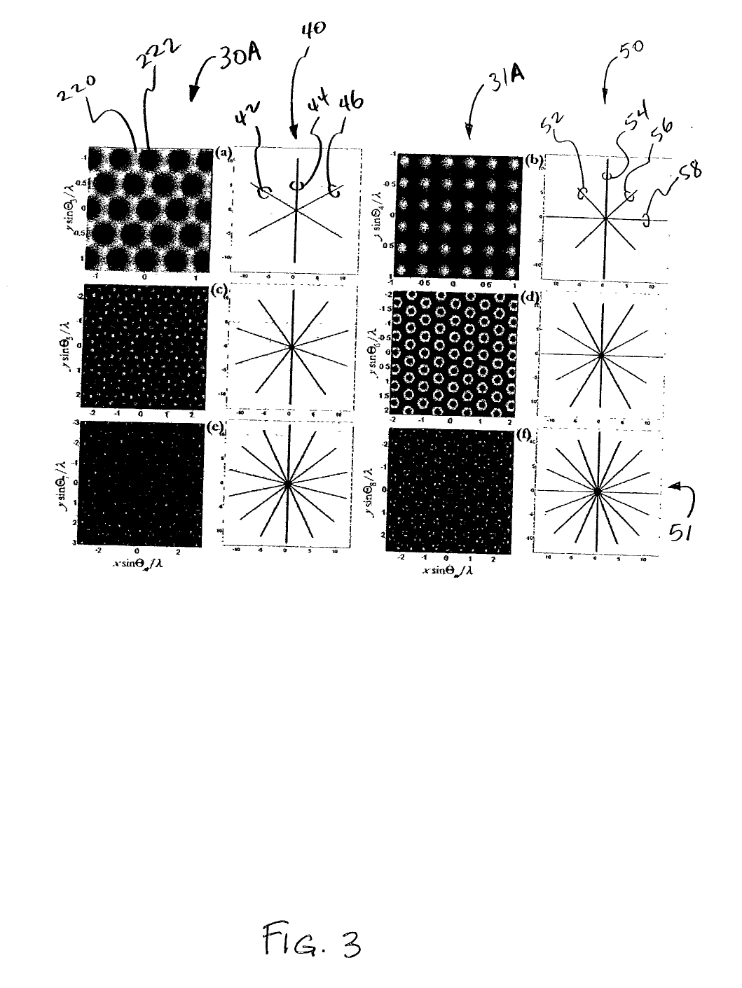

FIG. 3 illustrates several exemplary lattice symmetries and/or interference patterns of light obtainable from superposition of a plurality of coherent light beams. For example, panel 30A illustrates a hexagonal arrangement as described earlier in FIG. 2(a), having bright 200 and dark 222 regions obtained by superposition of three coherent light beams 42, 44 and 46, depicted in panel 40. Also, panel 31A illustrates yet another exemplary interference pattern of light obtained by superposition of four coherent light beams 52, 54, 56 and 58, shown in panel 50. Other exemplary intensity patterns of light may be obtained by interference of, e.g., five (FIG. 3(c)), six (FIG. 3(d)), seven (FIG. 3(e)) and eight (FIG. 3(f)) coherent light beams. Thus, the number of light beams and the nature of their combination can be varied to obtain substantially any desired structure or geometry.

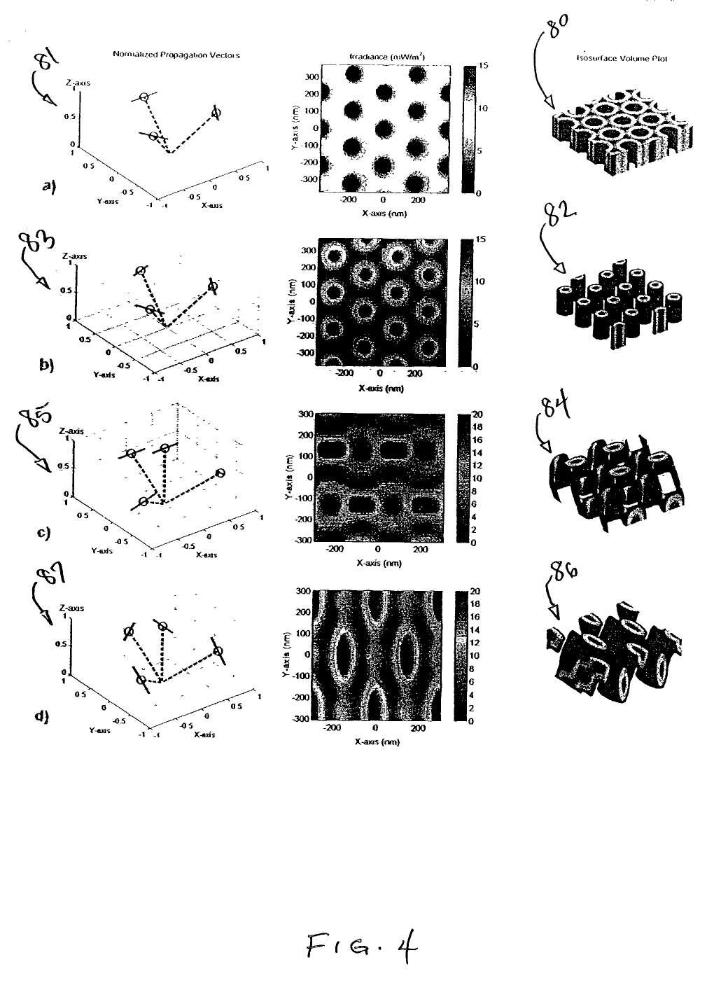

FIG. 4 illustrates a number of exemplary multi-dimensional light intensity patterns due to three or four coherent light beams. Normalized propagation vectors are illustrated on the left-hand side of the figure, irradiance patterns are illustrated in the center panels of the figure and isosurface volume plots are illustrated in the right-hand panels of the figure. For example, panel 81 illustrates three coherent beams having three normalized propagation vectors, which result in the isosurface volume plot illustrated in panel 80. It can be seen from this isosurface volume plot and also from the isosurface volume plot of panel 82 that three-dimensional structures having symmetry variation in two dimensions and no variation in the third dimension result. These structures may be called quasi-three-dimensional structures, and for the purpose of the present application will be in fact referred to as two-dimensional structures, because no variation occurs in the third dimension. Calculations of such structures only require computations to be performed in the two dimensions in which variation occurs, as the third dimension is assumed to be constant. On the other hand, by using four coherent beams, as shown in panels 85 and 87, more complicated isosurface volume plots are obtained. This is shown in panels 84 and 86, which are fully three-dimensional isosurface volumes. The structures shown in panels 84 and 86 have variation in all three dimensions and qualify as three-dimensional lattices.

Thus, various embodiments of the present system and method can be used to generate an essentially-arbitrary number of lattice shapes and arrangements. Such arrangements may include regular as well as irregular arrangements and may even include defects, which can be deliberately created by application of a defect-generating light beam or by superposition of more than one intensity pattern of light. Said beams may be coherent or incoherent. It can be seen in FIGS. 3(a)-3(f), as well as derived mathematically, that generally more complex patterns of light are obtainable when more light beams are used to generate the interference pattern. Cai et al. have demonstrated that any Bravais lattice structure could be produced by superposition of at least four coherent light beams (Cai, et al., Optics Letters, 27, 900-902).

While the present description presents the light beams as being generally superposed according to simple linear superposition rules, it should be understood that the generation and calculation of interference light patterns can be more complicated than a simple superposition. For example, especially at high amplitudes or in nonlinear materials, nonlinear behavior may be observed which may cause distortion, dispersion or other phenomena to take place in the propagation of an individual light beam or upon the interaction of one light beam with another. Nonetheless, nonlinear phenomena will not be explicitly addressed herein, and it will be assumed that, at least to low order, the behavior of the beams is linear and the overall interference effects are substantially-additive. Those skilled in the art would recognize that the concepts presented herein would extend into the nonlinear regime and would apply to nonlinear materials if such nonlinearities were present or substantial.

It should also be appreciated that the individual light beams used to obtain an interference pattern of light need not always be monochromatic or be of the same wavelength or intensity. Many ways exist for preprocessing and generating light beams, depending on the desired outcome. In other words, light beams of different wavelengths may be used to obtain the interference pattern of light, and light beams having the same wavelength but different intensities may also be used.

Depending on the photonic application desired, and depending on the specific performance criteria for the photonic device, various design considerations may be considered in deciding on a photonic lattice structure and the corresponding interference pattern of light to generate said structure. Some considerations which will typically be used in deciding on the particular choice of photonic lattice structure include the type of lattice which the device will comprise. For example, several types of Bravais lattices may be employed, including simple cubic, hexagonals, body-centered cubics, face-centered cubics and hexagonal close-packed lattices. In addition, the dimensions of the lattices including orientation and spacing of lattice planes can be selected depending on factors such as the wavelength of light with which they are intended to be used. A more complete discussion of crystal lattices in general may be found in the references disclosed herein, and more particularly, a thorough discussion of lattices used in photonic device applications is given in the doctoral dissertation of Michael J. Escuti, entitled “Structured Liquid Crystal/Polymer Composites as Photonic Crystal Switches and LCD Innovations,” Brown University, Providence, R.I., U.S.A. (2002), all of which are hereby incorporated by reference.

In one or more embodiments of the present invention, a plurality of light patterns are used to obtain the desired photonic lattice structure. Thus a monomer composition is exposed to a first light interference pattern to form a first lattice structure. A second light interference pattern is then superposed over the first to form a lattice pattern that is a combination of the two. The exposure conditions, e.g., time and intensity, may be adjusted to accommodate the two exposures. For example, the first exposure is selected so that the monomer is only partially polymerized and sufficient mobility remains in the composition for subsequent phase separation during the second exposure.

One or more embodiments of the present invention involve using the amplitude of an interference pattern of light to affect polymerization of a photosensitive monomer to create a photonic crystal lattice. However, other uses of coherent and incoherent light beams may also be found in various embodiments of the present invention. For example, rather than utilizing the amplitude of the interference pattern of light, one can use a polarization pattern to create photonic crystals and then use a special dye that changes its configuration (either cis or trans) which change the liquid crystal orientation locally, depending on said polarization pattern. This configuration may be maintained using a laser and then solidified using a blanket exposure of the bulk material so that the maintained pattern is held indefinitely.

In one embodiment of the polarization pattern process described above, a photosensitive composition is provided including a liquid crystal and a dye whose conformation changes from cis to trans depending on the incident polarization. Specifically, the conformation may be sensitive to a blue laser light and the polymer may be sensitive to a wavelength other than blue, such as in the ultraviolet (UV) range. The sample is then exposed to a polarization interference pattern created by a laser beam, such as a blue laser. Depending on the special direction of the polarization, molecules will either be in a cis or trans conformation, and will therefore locally align the liquid crystal. A photonic crystal is generated, since the liquid crystal follows the conformation of the dye molecule. To capture this configuration by polymerization, an ultraviolet light source may be used. The ultraviolet light source is applied to the entire sample during the laser exposure.

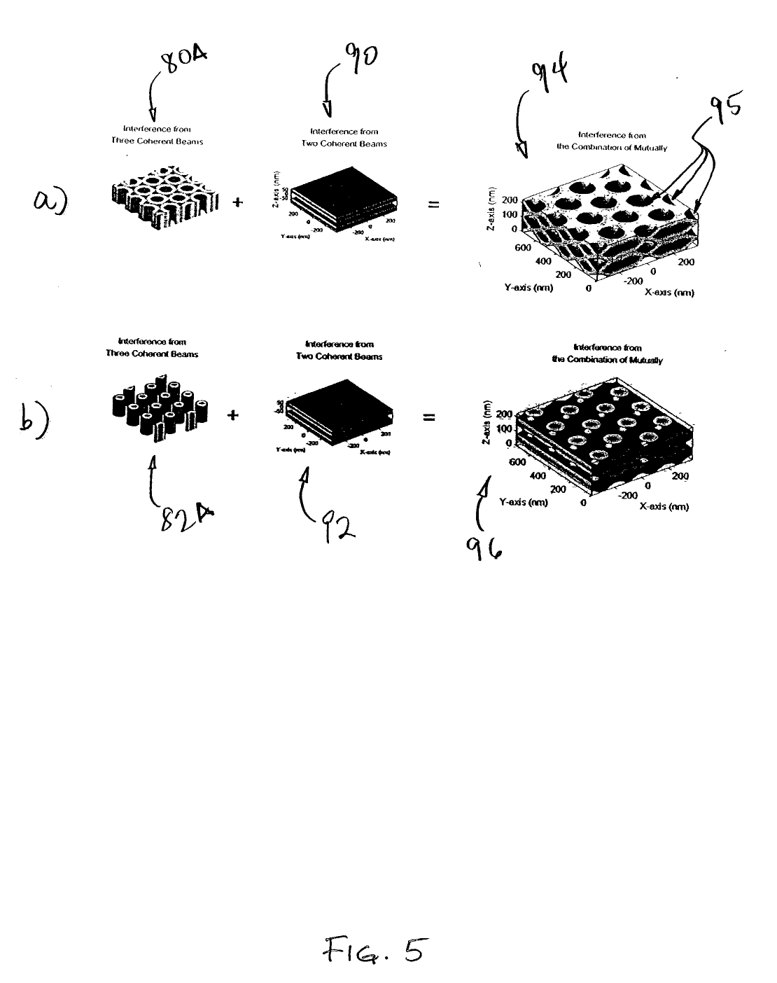

FIG. 5 illustrates a set of exemplary structures obtained in holographic PDLCs according to an embodiment of the invention. FIG. 5(a) illustrates interference from three coherent light beams generating a two-dimensional structure at panel 80A having characteristics being constant in the third (vertical) direction. To this two-dimensional pattern is added an interference pattern from two coherent beams as shown in panel 90. The two coherent beams interfere to create planar or sandwich-like patterns, which are then superposed onto the two-dimensional tube-like patterns in panel 80A to obtain the three-dimensional structure shown in panel 94. The variation along each of the x, y and z axes occurs in the crystal of panel 94. A second example is shown in FIG. 5(b) whereby the tube-like structures in 82A are superposed onto layers in panel 92 to obtain a three-dimensional structure as shown in panel 96.

The photonic crystal of FIG. 5(a) results in completely enclosed regions 95 that upon phase-separation of the photosensitive composition leaves pockets of non-photosensitive material substantially occupying the voids illustrated by 95 and lying within the polymerized polymer matrix. Such regions would not be fillable with a material using any of the back-filling methods of the prior art. That is, in the prior art methods for creating photonic crystals using polymers, the void spaces would need to be interconnected and open so that they may be back-filled or flushed subsequent to formation of the polymer matrix. However, according to aspects of the present invention, the non-photosensitive material phase separates into the dark regions of the interference pattern of light during the polymerization process. Hence, no backfilling is required and the liquid crystal or other active material or even a non-active filler material, which is not photosensitive may be used to fill internal, enclosed topologically-unconnected regions such as those illustrated by 95.

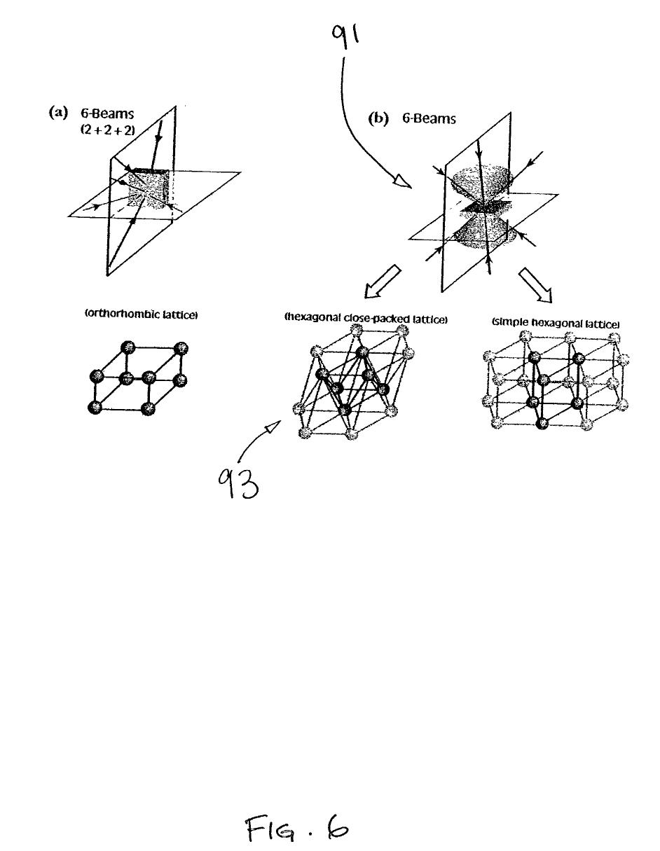

As discussed earlier, using multiple beams and increasing the number of interfering beams may provide in some cases for more complex structures and lattices. FIG. 6 illustrates the creation of a hexagonal close-packed lattice (hcp) 93 as well as a simple hexagonal lattice by using six beams as shown in panel 91 in FIG. 6(b).

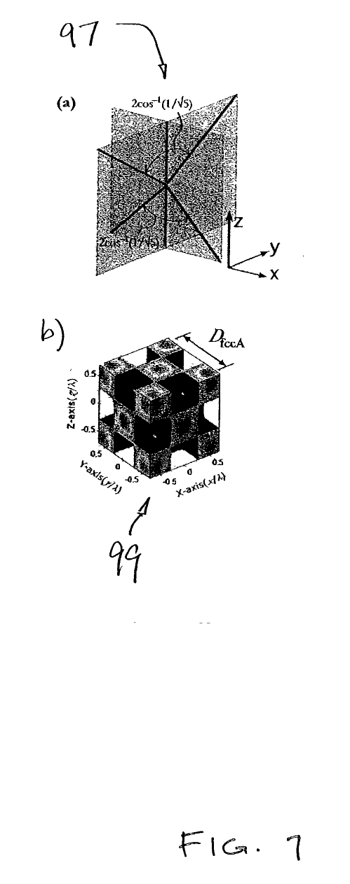

FIG. 7 illustrates the use of four coherent beams 97 to result in a face-centered cubic (fcc) lattice 99.

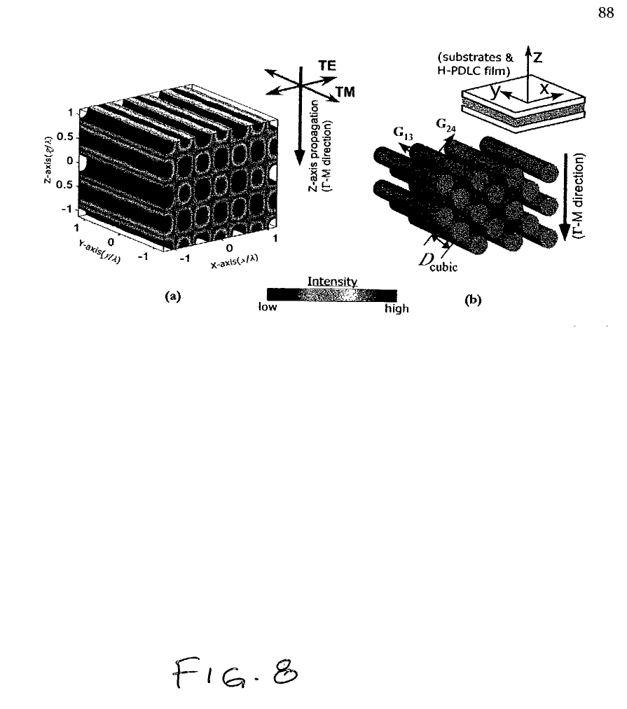

FIG. 8 illustrates an example of a transverse two-dimensional square lattice obtained by the method of the present invention. FIG. 8(a) illustrates a calculated irradiance pattern of high and low intensity of light. FIG. 8(b) illustrates the resulting shapes of the in-plane liquid crystal channels relative to the plane of the irradiated sample. The definitions of the TM (parallel to the y-axis) and the TE (parallel to the x-axis) polarizations are indicated. The transverse structure of FIG. 8 is in a plane parallel to a substrate.

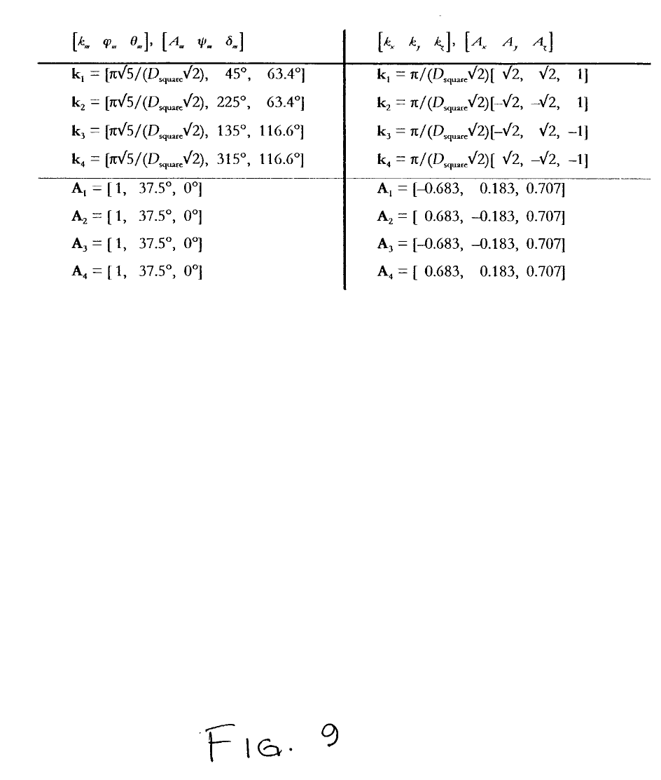

FIG. 9 illustrates in a tabular form an exemplary set of parameters and inputs which may be part of an input set used to calculate the intensity pattern of light of FIG. 8, above. The figure presents the propagation and normalized polarization vectors in two different coordinate systems, which will be described further below, and which are described in detail in the dissertation of Michael J. Escuti, Id. It can be appreciated that the parameters used in FIG. 9 are merely exemplary, and a large number of variations may be used to generate crystals having a corresponding variation of optical properties and behaviors.

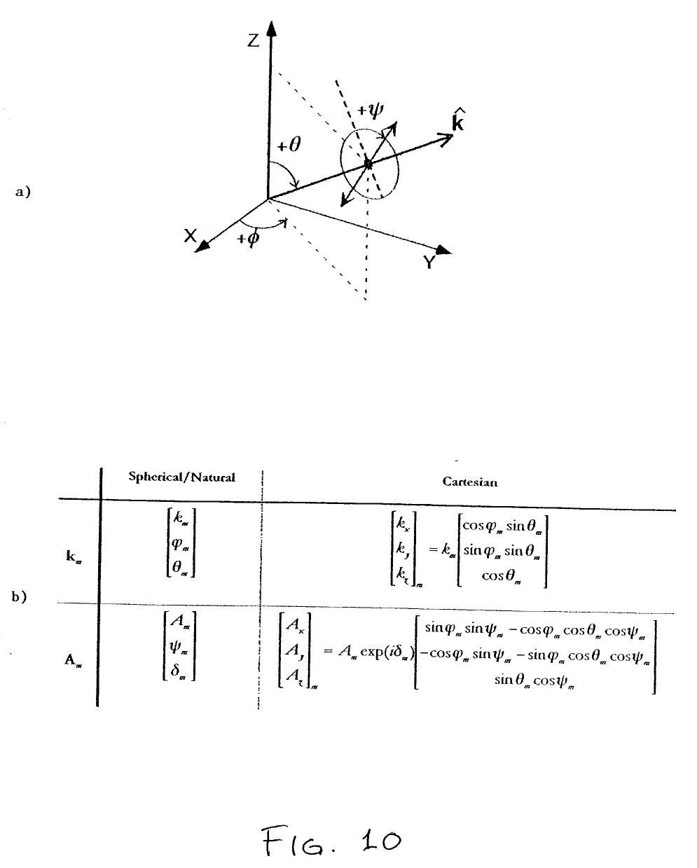

One convenient description developed by the present inventors is directed to the geometry and mathematics of vector representation in the context of optical and electromagnetic field vectors. FIG. 10(a) illustrates a three-dimensional space depicted by the axes x, y and z. Within the three-dimensional space it is possible to represent vectors in the well-known spherical coordinate system, which specifies a magnitude and two angles, theta (θ) and phi (φ). It is convenient in the present application to utilize a coordinate system referenced to the wave vector k such that k is used as a reference vector and an angle psi (ψ) is defined in a plane, substantially normal to the axis of the vector k. A table depicting the relationships between the wave vector k and the electric field vector A is given in FIG. 10(b), which gives the correspondence between spherical and Cartesian coordinates for both k and A.

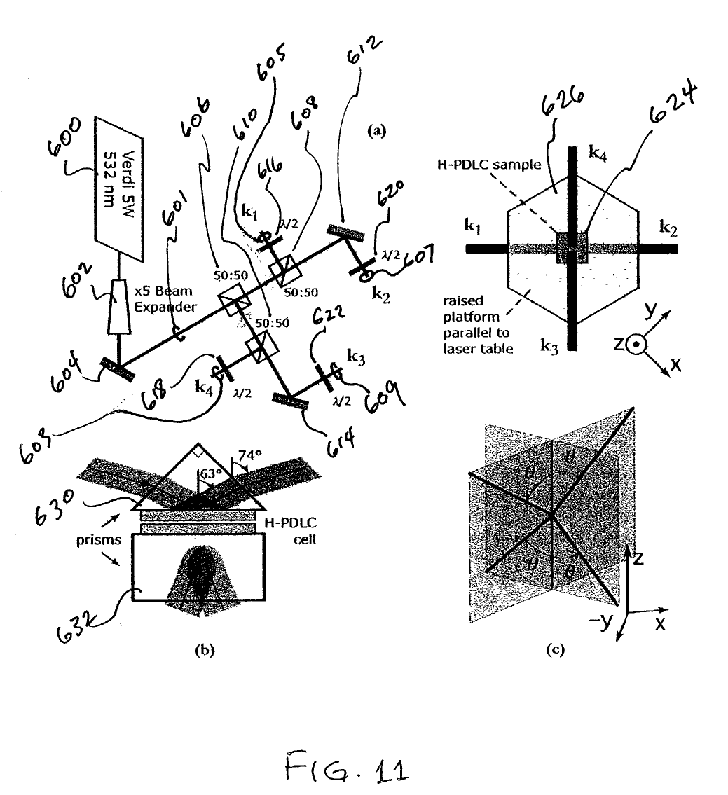

FIG. 11(a) illustrates a setup used to produce one or more of the photonic crystal structures and devices described herein. A laser device 600, such as a diode-pumped Nd:Y Verdi 5W laser, providing light at 532 nm is used as a source of coherent light. The coherent light is passed through a beam expander 602, which may be a 5×beam expander. The light is then reflected from a first mirror 604 and split into four distinct coherent beams 603, 605, 607 and 609, using 50:50 beam splitters 606, 608 and 610 and mirrors 612 and 614. Polarization is controlled using half-wave waveplates 616, 620 and 622. Also illustrated in FIG. 11(a) is the relative positioning of the sample 624 with respect to a raised platform 626, parallel to the laser table.

In some embodiments, prisms may be used to adjust the angle of light incident on the sample. By way of example, two 90° prisms 630 and 632 may be used as illustrated in FIG. 11(b) to achieve a desired oblique angle of propagation within a film. A lattice constant of 271 nm is used with a first refractive index being 1.55. Finally, FIG. 11(c) illustrates the 4-beam geometry used within the sample according to this embodiment. A method for making a photonic crystal using the apparatus discussed above will be described in more detail below.

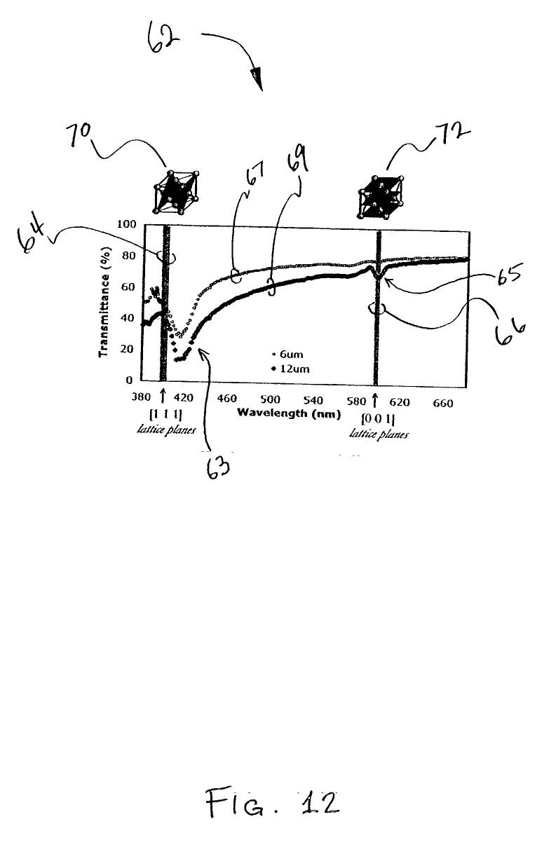

FIG. 12 illustrates exemplary light transmission properties of a fcc photonic crystal generated using holographic methods to yield samples having thicknesses of 6 micrometers (curve 69) and 12 micrometers (curve 67). Broadband light is normally incident onto the samples and the transmittance is observed as a function of wavelength. Several notches (or low transmittance bands) appear in the transmission spectrum from different lattice planes. A first notch at approximately 600 nm from the [001] lattice planes is observed. In addition, a second notch at approximately 400 nm is obtained from the [111] lattice planes of the fcc sample. Higher or lower values for the wavelength of the notches are obtained as the sample is tilted with respect to the incident light and light encounters the various lattice planes. More detailed examples of the optical properties and transmission phenomena described above can be found in the dissertation of Michael J. Escuti, Id.

As mentioned previously, an active photonic crystal device may be modulated, or switched, or otherwise controlled. This can be accomplished by modulating, switching or controlling an external field that influences a property of an active material or the crystal as a whole. For example, a liquid crystal material can be influenced by application of an external electromagnetic field. Controlling the external field using a controller would provide ways for affecting the behavior of the photonic crystal and achieving optical results that can have commercial and/or scientific use. Some applications have already been given in this regard and others will become apparent to those skilled in the art upon reading the instant disclosure, and will not be repeated here.

In some embodiments, it is possible to selectively use a liquid crystal and polymer components of the photonic crystal exhibiting index mismatching at two different external field strengths. Such index mismatching may be a mismatching at a resting and at an applied field strength. Applications of photonic crystals with index mismatching have been exploited in single-layer H-PDLC devices capable of switching between various operating wavelengths. For example, rather than a single grating providing reflection at a single wavelength, it is possible to continuously modify the reflection peak of the single grating by applying a variable external field, influencing the liquid crystal.

Specifically, a device may process at least two reflection wavelengths, each reflection wavelength associated with a different applied field strength. The liquid crystal may have an ordinary index of refraction, n₀, and an extraordinary index of refraction, nₑ, and the polymer may have a refractive index, nₚ, wherein n₀is not equal to nₚ. Additionally, the above-discussed indices of refraction may be related by nₑ>nₚ>n₀. In such devices, different color states may be achieved at different applied field strengths.

One or more embodiments of the present invention are directed to reflective display applications. As described elsewhere in this application, a reflection grating may be formed using the method of the present invention. In one specific example directed to reflective displays, five light beams are used to generate the reflection grating. A first pair of self-coherent beams are obtained from a diode-pumped Nd:Y laser at 532 nm and a triplet of three self-coherent beams derived from an Argon ion (Ar+) laser operating at 351 nm. The first pair of beams from the Nd:Y laser form a reflection grating and the triplet of beams from the Argon ion laser form an in-plane grating. The reflection grating is formed using approximately 80 mW/cm² per beam to obtain a lattice constant of approximately 195 nm and the in-plane beams are applied using approximately 10 mW/cm²per beam to obtain a lattice constant of approximately 191 nm. All beams are S-polarized. The resulting lattice structure is a simple hexagonal Bravais lattice having two-dimensional triangular arrays stacked directly above one another at an aspect ratio of about 1:1.

For the above device a liquid crystal/pre-polymer is used comprising a blend of urethane acrylate tri-hexa-functional oligomers mixed with a nematic liquid crystal (such as BL038 from EM Industries). To this composition is added a photo-initiator such as Rose Bengal and a coinitiator NPG as well as a mono-functional solvent NVP. The ratio of monomer to liquid crystal to photo-initiators is approximately 50:36:14.

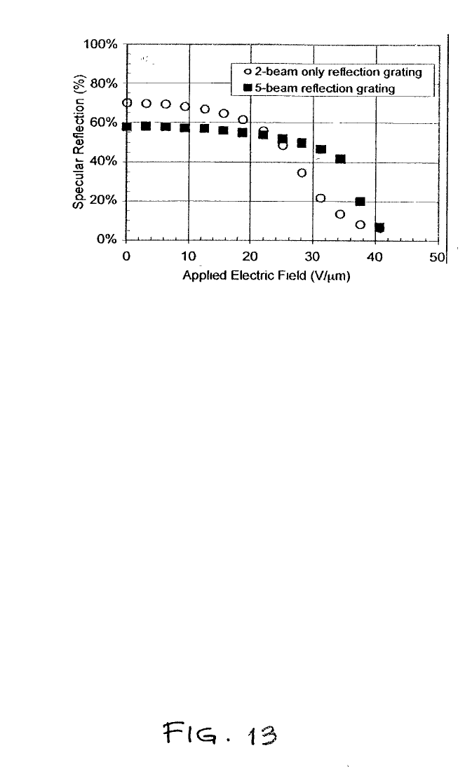

The structure described above and obtained using the five beams displays a pronounced change in the peak reflection versus applied external electric field curve when compared with a grating obtained with only two beams. This is illustrated in FIG. 13. Additionally, as compared to a conventional two-beam reflection grating, the five-beam grating reveals an electro-optic curve that is substantially more linear and having a more sudden transition.

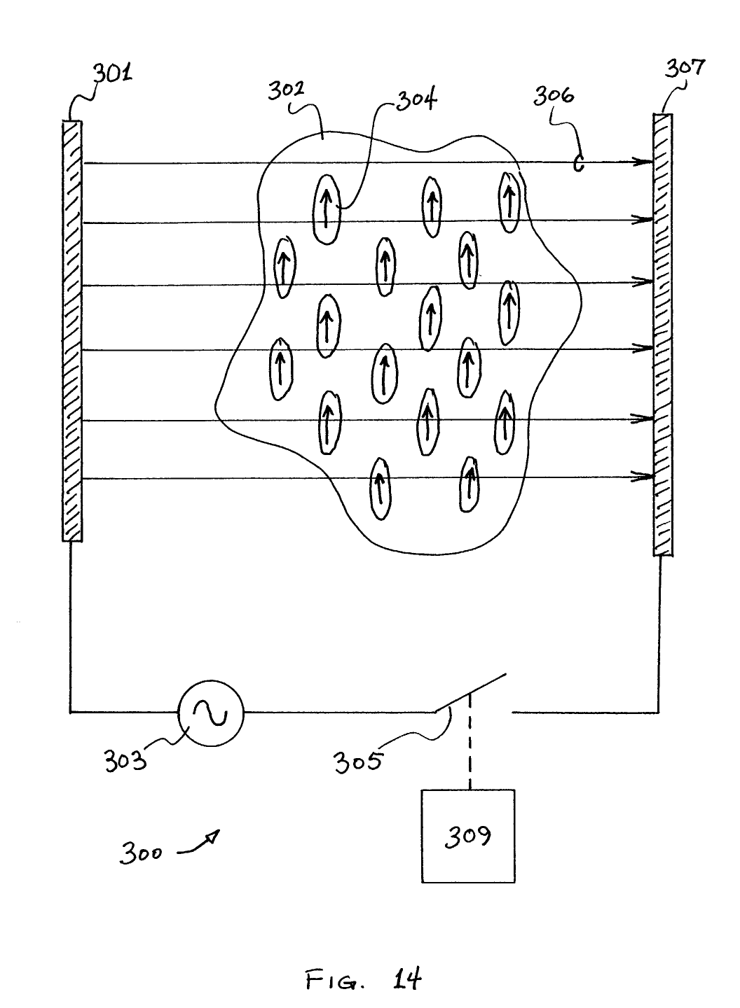

FIG. 14 illustrates a simple circuit 300 which may be used for controlling an external field to influence an active photonic crystal lattice. An electrical source such as an alternating current (AC) voltage supply 303 is coupled to a first electrical plate 301 and to a second electrical plate 307 through switch 305. Switch 305 may be controlled by a controller 309 to then modulate the output of electrical source 303. A field such as an electromagnetic field may be generated when switch 305 is closed causing electrical field lines 306 to pass through a sample containing a matrix 302 and an active material 304 disposed within matrix 302. Controller 309 may be manually, or automatically, or programmably actuated to control switch 305 or any other aspect of the system to achieve the modulation of electrical field 306.

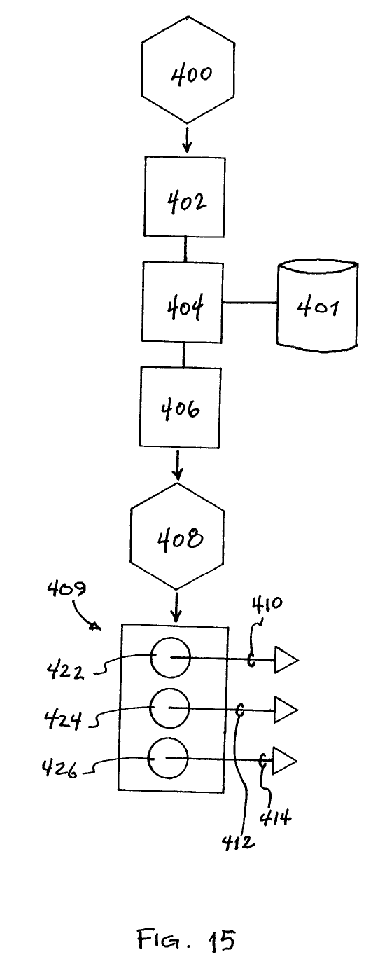

As an example of a system which may be used to modulate an active photonic crystal, FIG. 15 illustrates schematically a processor such as a computer system 404, coupled to an input interface 402 for the purpose of receiving input data 400. The input data 400 may comprise executable instructions or instructions adapted for compiling for subsequent execution by processor 404. In addition, input data 400 may comprise numerical or other types of information such as data structures or tabulated parameters of one or more properties of an interference pattern of light or photonic crystal which is desired to be manufactured with the aid of such a system. For example, data corresponding to the number of coherent light beams, the wave vectors of each of the coherent light beams and/or electromagnetic fields used to generate the coherent light beams may be input into interface 402. Governing equations such as Maxwell's Equations or other equations relating to the physics of the coherent light beams or their interaction may also be input through input interface 402.

In addition to the input interface 402, processor 404 may be coupled to a storage device 401 which is adapted for storing any instruction or data thereon. Storage device 401 may be in the form of a magnetic storage device, remotely or locally disposed with relation to the processor 404, or may be any other type of data storage medium suitable for containing information to be used by processor 404 in subsequent calculations. For example, rather than receiving the executable instructions described earlier from input interface 402, such executable instruction may be preloaded and stored in the storage device 401. Other parameters such as tabular lists of material properties, wavelengths, or other information identifying optical or polymer properties may also be stored on storage device 401.

It should be appreciated that hardwired connections are not the only way for receiving information and sending information to and from the processor 404. Processor 404 may be coupled to other components of the system by any suitable communication means such as wireless connections including infrared, microwave and radio frequency (RF) communication channels. Also, processor 404 may interact with information and components over a network which may be a local network or an extended network such as the Internet.

Processor 404 performs calculations required to determine a desired optical interference pattern such as an intensity pattern of light and provides output corresponding to the calculations to an output interface 406. Output interface 406 may be coupled to the processor 404 by any of the methods described previously and is adapted to further provide output data 408 to a holography system 409.

It should also be appreciated that the system described herein may be implemented as discrete components or that some or all of the components may be implemented in a unified package containing the components. That is, off the shelf computer systems and communication systems could be used to couple a computer such as processor 404 to a holography system 409. However, a computer system including processor 404 may be an integral part of an overall holography system including the computer system and the holographic generation apparatus 409. Holographic system 409 comprises a plurality of sources 422, 424 and 426. Said sources may receive light from a single source which is then split into the plurality of sources or independent sources may be used to create coherent light beams as called for by the application at hand. Output coherent light beams 410, 412 and 414 are then generated and may be used as described elsewhere in this application to polymerize a photosensitive monomer to generate a polymer matrix and to create a photonic crystal resulting therefrom.

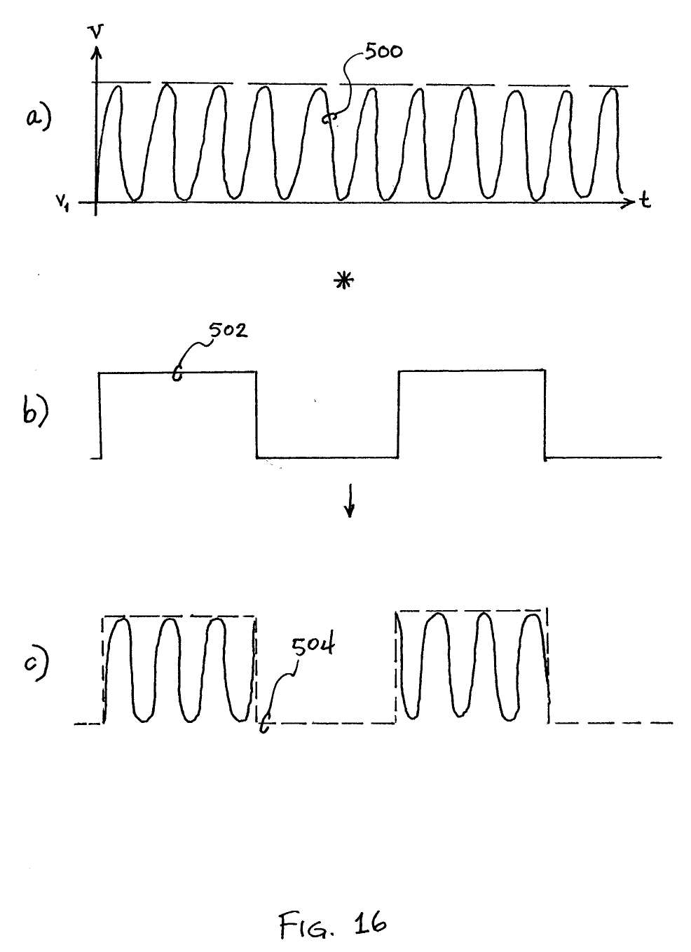

FIG. 16 illustrates an exemplary modulation scheme for modulating an external field such as shown previously in FIG. 10. In FIG. 16(a) an alternating current (AC) source provides a signal such as a voltage 500 which oscillates between two values V₁ and V_{2.} In one embodiment the value of V₁ is zero volts and the value of V₂ is 20 volts. Generally, the amplitude of the oscillation is determined by a distance separating electrode plates 301 and 307, as well as the desired field strength to be used in the active material.

FIG. 16(b) illustrates a modulating square wave pattern 502 used to modulate the alternating current oscillating signal 500. In one embodiment, square wave 502 oscillates at a frequency of approximately 2 kHz to yield the modulated signal shown in FIG. 16(c). Modulation of the external field may be performed by switching the external field on and off in a binary fashion or may be performed in a more complicated way by applying an amplitude modulating envelope to the alternating oscillating signal 500 rather than the square wave 502. Any algorithm may be used for modulating the external field depending on the desired outcome.

As described herein, and in one or more embodiments of the present invention, a polymer matrix may define lattice regions filled with an active material to form a photonic crystal. Active materials may comprise liquid crystals such as thermotropic liquid crystals with molecules that have applications in electro-optic devices. For example, a nematic liquid crystal may be used, which exhibits uniaxial orientational order without positional order. Also, chiral nematic liquid crystals can be used, which have an additional degree of orientational order but still no positional order. A chiral element causes a nematic director to rotate in the helical fashion, transverse to the helical axis. In addition, smectic liquid crystals may be used, sometimes known as ferroelectrics due to the presence of a permanent dipole therein, layered in planes of fluid-like tilted molecules. The tilt from layer to layer follows a heliacal twist similar to the chiral nematic liquid crystals.

In addition to the exemplary liquid crystals described above, other types of materials and liquid crystals may be used for the same or similar purposes. For example, electroclinic liquid crystals may be used that possess a permanent dipole moment and are layered in bookshelf patterns similar to ferroclectric liquid crystals with no tilt in the absence of an external applied field. Upon application of an external field, a tilt is observed, and the tilt may gradually change. Another type of liquid crystal, which may be used in some or all embodiments of the present application, includes a conventional smectic A liquid crystal having molecules layered in bookshelf-like planes. In such liquid crystals it is possible to create a photonic crystal and to permanently or semi-permanently align the liquid crystal in a particular direction. To restore the crystal to its original state, heat is applied rather than an external electric field until the crystal reaches an isotropic phase and then a cooling process will reconfigure the liquid crystal. In this way it is possible to address or write onto the photonic crystal using an external electromagnetic field and then erase the configuration of the photonic crystal using heating. One possible application for such a technology includes in the field of thermometry, wherein an irreversible thermometer may be created. Furthermore, discotic materials may be used that have a disk shape rather than a rod shape or another shape. These materials may form nematic-like phases and other higher-order columnar phases.

In some embodiments, the photonic crystal may be used as an optical switching device in which case the active material is influenced by the external field to affect the propagation of a light beam used in a communication signal. The light beam may be modulated by the photonic crystal and the external field in a way to communicate information passing through the photonic crystal. Also, other embodiments of the photonic crystal may be used to redirect light or to shift a band gap which affects the wavelengths capable of passing through the photonic crystal.

In some embodiments, including those described throughout this application, a miscible composition may be used, instead of an active material or a liquid crystal, to fill the regions within the polymer matrix. For example, an oil may be used, or another colloidal suspension containing a powder or fiber such as ferromagnetic flakes or gold flakes suspended within a fluid. In some aspects, the desired outcome would be to achieve an index difference between the polymer matrix and that material filling the spaces within the polymer matrix. Any such device may be used as a photonic crystal including crystals which do not form an absolute and complete photonic band gap, rather provide a partial photonic band gap.

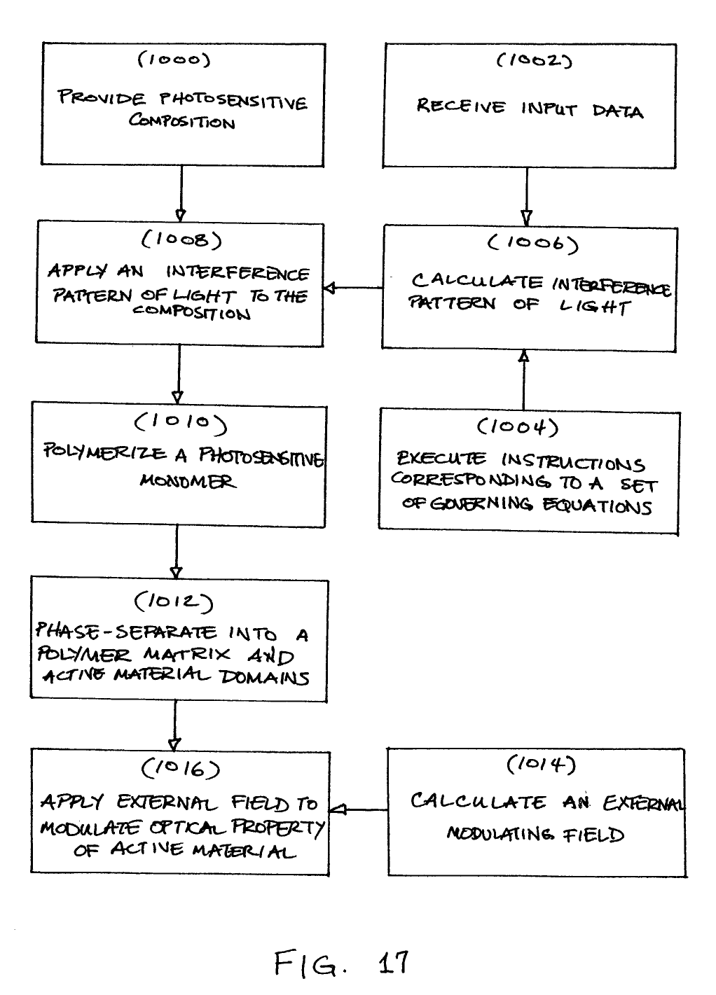

FIG. 17 illustrates an exemplary group of acts performed in making and using an active photonic crystal. In act 1000, a photosensitive composition is provided. In act 1002, input data corresponding to the photonic crystal or interference pattern of light is provided to a processor. In act 1004, instructions are executed on the processor, said instructions corresponding to a set of governing equations. Using the received input data from act 1002, and operating on the instructions corresponding to the set of governing equations from act 1004, a processor may calculate an interference pattern of light in act 1006. The interference pattern of light derived in act 1006 may be applied to the photosensitive composition in act 1008.

As discussed previously, a photosensitive monomer in the photosensitive composition is polymerized in act 1010. Polymerization results in phase separating the composition into a polymer matrix and an active material domain in act 1012. An external field, such as an electromagnetic field, may be applied to the lattice obtained in act 1012 to modulate an optical property of the active material within the polymer matrix in act 1016. The external field may be calculated and used to modulate the optical property, such as the index of refraction, in a calculation performed in act 1014.

Although the present invention has been described in relation to particular embodiments thereof, many of the variations and modifications, as well as applications of the invention, will become apparent to those skilled in the art upon reviewing the present disclosure. Therefore, the present invention shall not be limited by the specific embodiments described herein, but rather by the scope of the appended claims.

What is claimed is:

1. A method for modulating a light source, comprising:
providing a composition including a photosensitive monomer and an active material;
forming an interference pattern of light from at least three substantially-additive coherent light beams;
applying the interference pattern of light to the composition;
polymerizing the photosensitive monomer, thereby phase-separating the composition into a polymer matrix and a plurality of active material domains, said active material domains arranged in a two- or three-dimensional lattice; and
applying an external field to the active material to modify an optical characteristic of the active material and modulate the light source.

2. The method of claim 1, wherein the active material comprises a liquid crystal.

3. The method of claim 1, wherein the active material domains comprise topologically-unconnected regions substantially occupied by the active material.

4. The method of claim 3, wherein the active material domains comprise topologically-unconnected regions are closed.

5. The method of claim 4, wherein the topologically-unconnected closed regions are contained within the polymer matrix.

6. The method of claim 1, wherein the polymer matrix comprises domains of topologically-unconnected regions substantially occupied by the polymer.

7. The method of claim 1, wherein the topologically-unconnected regions are closed.

8. The method of claim 1, further comprising calculating an intensity field of the interference pattern of light using an algorithm.

9. The method of claim 8, wherein the algorithm comprises a series of mathematical steps corresponding to a set of governing equations.

10. The method of claim 1, further comprising modulating an amplitude of the external field between a first amplitude and a second amplitude.

11. The method of claim 10, wherein the optical characteristic has a first value at the first amplitude and a second value at the second amplitude.

12. The method of claim 10, wherein the first amplitude is substantially zero.

13. The method of claim 1, wherein the external field is an electromagnetic field.

14. The method of claim 1, wherein the external field comprises a modulated alternating current (AC) signal.

15. The method of claim 1, wherein the optical characteristic is an index of refraction.

16. The method of claim 1, further comprising calculating a set of lattice constants defined by the interference pattern of light.

17. The method of claim 1, wherein the interference pattern corresponds to a plurality of superposed lattice patterns.

18. The method of claim 1, wherein the interference pattern corresponds to a Bravais lattice.

19. The method of claim 18, wherein the Bravais lattice comprises a hexagonal close packed (HCP) lattice.

20. The method of claim 18, wherein the Bravais lattice comprises a face-centered cubic lattice (FCC).

21. The method of claim 1, further comprising applying a defect-generating pattern of light to the composition to generate defects within the lattice.

22. An optical device, comprising:
a substantially-solid three-dimensional polymer matrix; and
an active material disposed in and substantially filling a plurality topologically-unconnected, closed domains within the polymer matrix, said domains defining locations of a three-dimensional lattice, wherein the active material has an optical characteristic that may be actively controlled using an externally-applied field.

23. The device of claim 22, wherein the optical characteristic is an index of refraction.

24. The device of claim 22, wherein the active material and the polymer matrix have different indices of refraction.

25. The device of claim 22, wherein the externally-applied field is an electromagnetic field.

26. The device of claim 22, wherein the active material comprises any of: a liquid crystal, a composite and a suspension.

27. The device of claim 22, wherein the device provides a tunable photonic band gap that selectively substantially blocks propagation of light within a frequency range defined by the band gap.

28. The device of claim 22, wherein the device provides a tunable polarizer.

29. The device of claim 28, wherein the tunable polarizer operates in a selected frequency band.

30. The device of claim 22, wherein the polymer matrix is formed by polymerizing a photosensitive monomer using a holographically-generated interference pattern of a plurality of coherent light beams.

31. The device of claim 30, further comprising a defect within the active material lattice.

32. The device of claim 22, wherein the topologically-unconnected, closed domains of active material are formed by phase separation of the active material from the polymer matrix.

33. The device of claim 22, wherein the three-dimensional lattice has a pattern that corresponds to a plurality of superposed lattice patterns.

34. The device of claim 22, wherein the lattice comprises a Bravais lattice.

35. The device of claim 34, wherein the Bravais lattice comprises a hexagonal close packed (HCP) lattice.

36. The device of claim 34, wherein the Bravais lattice comprises a face-centered cubic lattice (FCC).

37. A computer system for calculating an interference pattern of light for application to a photosensitive material, the computer system comprising:
a storage device that stores instructions corresponding to a governing set of equations;
an input interface that receives input data corresponding to a desired optical characteristic of the photosensitive material;
a processor operative to receive the input data, execute the stored instructions on the input data to calculate an intensity field for each of a plurality of simulated coherent light beams and sum the calculated intensity fields to yield a simulated two- or three-dimensional interference pattern of light having a plurality of bright or dark regions; and
an output interface that provides an output representative of the simulated two- or three-dimensional interference pattern of light, the output adapted for generation of an actual two- or three-dimensional interference pattern of light that locally modifies an optical characteristic of the photosensitive material corresponding to the bright or dark regions.

38. The computer system of claim 37, wherein the processor is further operative to execute instructions to calculate an external field acting on the photosensitive material, and to generate a corresponding output operative to modulate the optical property of the photosensitive material.

39. The computer system of claim 37, wherein the input data includes data identifying a wave vector and a polarization vector for at least one of the simulated coherent light beams.

40. The computer system of claim 39, wherein the polarization vector is defined with respect to the wave vector.

41. The computer system of claim 37, wherein the stored instructions comprise a photonic band gap solver.

42. The computer system of claim 37, wherein the stored instructions comprise a multi-beam holographic interference solver.

43. The computer system of claim 37, further wherein the output interface is coupled to a beam controller that controls the coherent light beams.

44. The computer system of claim 37, further wherein the processor is further operative to calculate an interference pattern of light corresponding to a superposition of a plurality of lattice patterns.

45. A method for making an active optical component, comprising:
providing a composition including a photosensitive monomer and an active material;
forming an interference pattern of light from at least three substantially-additive coherent light beams;
applying the interference pattern of light to the composition; and
polymerizing the photosensitive monomer, using the interference pattern of light, thereby phase-separating the composition to yield a polymer matrix and a two- or three-dimensional lattice of the active material within the polymer matrix.

46. The method of claim 45, wherein the active material comprises any of: a liquid crystal, a composite and a suspension.

47. The method of claim 45, wherein the two- or three-dimensional lattice comprises topologically-unconnected domains substantially occupied by the active material.

48. The method of claim 47, wherein the topologically-unconnected regions are closed.

49. The method of claim 45, further comprising modulating an optical characteristic of the active material using an external field applied to the active material.

50. The method of claim 49, wherein the external field is an electromagnetic field.

51. The method of claim 45, wherein the at least three substantially-additive coherent light beams irradiate the photosensitive monomer from a same face of the composition.

52. The method of claim 45, further comprising applying a defect-generating pattern of light to the composition to generate defects within the lattice.

53. The method of claim 45, wherein forming the interference pattern of light comprises forming at least two patterns of light and applying the interference pattern of light comprises applying the at least two patterns of light in separate steps.

54. The method of claim 53, wherein the at least two patterns of light are applied in temporally distinct stages.

55. The method of claim 53, wherein the at least two patterns of light are applied to a corresponding at least two distinct spatial regions.

56. A photonic device fabrication method, comprising:
applying light in a light intensity pattern to a composition including a photosensitive monomer and an active material;
phase-separating the composition by polymerizing the photosensitive monomer into a polymer matrix having a three-dimensional morphology corresponding to the light intensity pattern, including a plurality of active material-filled topologically-unconnected, closed regions contained within the polymer matrix;
wherein said regions define locations of a three-dimensional lattice; and
wherein all regions of the polymer matrix are formed substantially at the same time and globally over the device in its entirety by exposing the device as a whole to the light intensity pattern.

57. The method of claim 56, wherein the active material comprises a liquid crystal.

58. The method of claim 56, further comprising calculating a light intensity pattern using a multi-beam holographic interference solver.

59. The method of claim 56, further comprising calculating a light intensity pattern corresponding to a superposition of a plurality of lattice patterns.

60. A method for making a photonic device, comprising:
applying light in a light intensity pattern to a composition including at least a first material and a second material, said first material having a first index of refraction and said second material having a second index of refraction, wherein said first and second indices of refraction are different and wherein at least said first material is a photosensitive monomer;
phase-separating said composition into a plurality of regions by polymerizing at least said first materials to yield a polymer matrix and a plurality of topologically-unconnected regions disposed within said polymer matrix;
wherein said topologically-unconnected regions comprise a lattice having domains substantially occupied by second material.

61. The method of claim 60, wherein said second material comprises a monomer.

62. The method of claim 60, wherein said second material comprises a polymer.

63. The method of claim 60, wherein said second material comprises a composite.

64. The method of claim 63, wherein said composite comprises a suspension.

65. The method of claim 64, wherein said suspension comprises an active material.

66. An optical device, comprising:
a composition that is phase-separated by application of a light pattern into a first region comprising a substantially-solid three-dimensional polymer matrix comprising a first polymer having a first index of refraction; and
a second region comprising a second polymer, having a second index of refraction, disposed in and substantially filling a plurality topologically-unconnected, closed domains within the polymer matrix, said domains defining locations of a three-dimensional photonic lattice.

67. The device of claim 66, wherein the active material and the polymer matrix have different indices of refraction.

68. The device of claim 66, wherein the device provides a photonic band gap that selectively substantially blocks propagation of light within a frequency range defined by the band gap.

69. The device of claim 66, wherein the polymer matrix is formed by polymerizing a photosensitive monomer using a holographically-generated interference pattern of a plurality of coherent light beams.
